(19) United States
(12) Patent Application Publication
(10) Pub. No.: US 2007/0215704 A1
(43) Pub. Date: Sep. 20, 2007

(54) IMAGE PROCESSING DEVICE

(76) Inventors: Takamitsu YAMADA, Kanagawa (JP); Mutsuo Ogawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/678,874

(22) Filed: Feb. 26, 2007

(30) Foreign Application Priority Data
Mar. 16, 2006 (JP) 2006-073334

(51) Int. Cl. G06K 7/10

(52) U.S. Cl. 235/454

(57) ABSTRACT

An image processing device includes an information extracting unit that extracts information from a physical mark attached to a scanned document, and a user identifying unit that identifies a user. The image processing device also includes a traceability-information generating unit that generates traceability information from the information extracted by the information extracting unit, and a process selecting unit that causes the user to select at least one process for the scanned document. The image processing device generates a document attached with a new physical mark that contains the traceability information according to selected process.

### CROSS-REFERENCE TO RELATED APPLICATIONS

The present document incorporates by reference the entire contents of Japanese priority document, 2006-073334 filed in Japan on Mar. 16, 2006.

### BACKGROUND OF THE INVENTION

1. Field of the Invention

The present invention generally relates to an image processing device.

2. Description of the Related Art

In recent years, there has been a technology that offers users easy access to digital data in a server by capturing a barcode or a watermark printed on paper or the like by a mobile terminal with camera, thereby improving convenience for the users.

Japanese Patent Application Laid-Open No. H8-22456 discloses a management device that manages documents by attaching a barcode to the documents. Japanese Patent Application Laid-Open No. 2004-62304 discloses a technology in which a Uniform Resource Locator (URL) is extracted by reading a barcode on a paper document with a barcode reader to access and retrieve a digital document through the Internet. Japanese Patent Application Laid-Open No. 2002-544637 discloses a technology in which information to control a remote server is extracted from a physical mark and a watermarked image, thereby providing easy access to a document in the server and URL.

On the other hand, in recent years, due to an increase in threats to leakage of confidential information, information security has attracted considerable attention. The reasons behind such threats relate to numerous incidents of leakage of customer information possessed by companies, enforcement of private information protection law, and increased concern for business compliance. At present, efforts taken by companies, with respect to information security, is a determining factor in attracting customers. In such a situation, companies have resulted in using security solutions such as information security management system (ISMS) authentication to determine a degree of efforts on security issues based on an objective standard.

Japanese Patent Application Laid-Open No. 2004-192610 discloses a technology in which limitations on users, denial of operation, and limitations on operation are managed by a security policy server to ensure security of information in a document. Japanese Patent Application Laid-Open No. 2004-280227 discloses a technology that facilitates traceability by creating a watermark on a printed document. When a user is to copy a document with a watermark, a server authenticates the user and manages copying operation.

Such information security attempts deny users easy access to a digital document by use of a barcode or a watermark.

Further, the conventional technologies related to information security require substantial initial investment for setting up server facilities and allocating dedicated system administrators. Otherwise, the information security needs to be entrusted to outsourcing.

However, a small-scale office such as a small office/home office (SOHO) or a small and medium-scale company that cannot afford dedicated system administrators has difficulty in raising funds for server facilities and management thereof or outsourcing.

Further, the conventional technologies strengthen security by limiting or denying access to data or information. However, if the SOHO or the small and medium-scale company with a small number of employees is not handling customer information, there is no need to enhance security at the cost of convenience for users.

### SUMMARY OF THE INVENTION

It is an object of the present invention to at least partially solve the problems in the conventional technology.

According to an aspect of the present invention, an image processing device that is applied to an image forming apparatus that performs at least one of image processes including copying, printing, and faxing, includes a selecting unit that causes a user to select at least one of the image processes for data, an information extracting unit that extracts, when a specific mark is attached to the data, information contained in the specific mark, an identifying unit that identifies the user to obtain an identification result, a traceability-information generating unit that generates traceability information of the data from extracted information and the identification result, and an update data generating unit that generates update data attached with a specific mark that contains generated traceability information based on selected image process.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of an image forming apparatus that includes an image processing device according to a first embodiment of the present invention;

FIG. 2 is a schematic of an image processing device according to a second embodiment of the present invention;

FIG. 3 is a schematic of an image processing device according to a third embodiment of the present invention; and

FIG. 4 is a flowchart of a process procedure performed by the image processing device shown in FIG. 2.

### DETAILED DESCRIPTION OF THE PREFERRED EMBODIMENTS

Exemplary embodiments of the present invention are explained in detail below with reference to the accompanying drawings. In the embodiments described below, an image processing device is configured to, when entire text of a document is already digitized into digital data and stored in a hard disc or a remote server such as an internet data center (IDC), read the document attached with a mark to retrieve the digital data. The mark contains a document identification (ID) for searching the digital data. The embodiments are explained using a Multifunction Product (MFP) as an image forming apparatus.

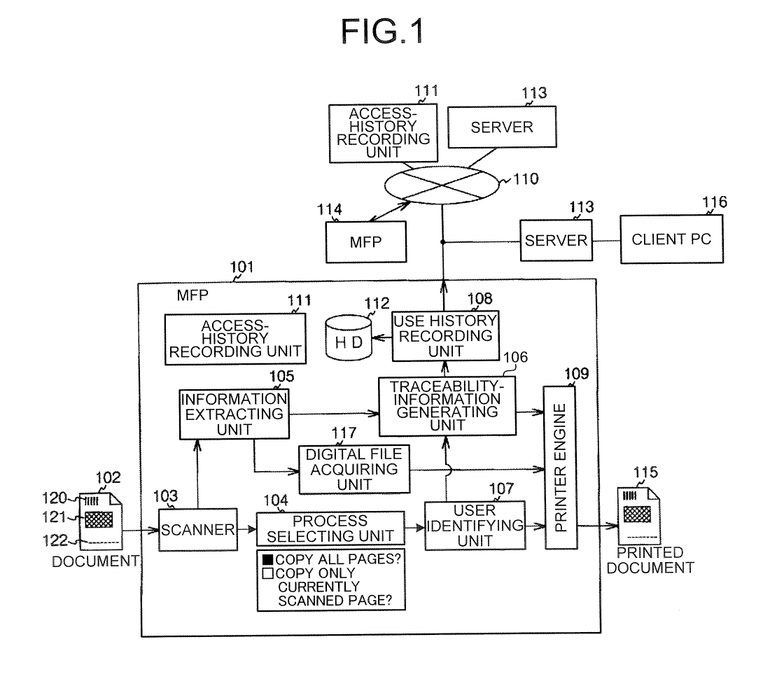

FIG. 1 is a schematic of an MFP 101 that includes an image processing device according to a first embodiment of the present invention.

The MFP 101 includes a scanner 103 that reads data such as an image and a document, and a printer engine 109 that is an image forming unit. The MFP 101 has a fax function (communication function) and the like (not shown).

The image processing device includes a process selecting unit 104, an information extracting unit 105, a traceability-information generating unit 106, a user identifying unit 107, a use history recording unit 108, an access-history recording unit 111, a hard disk drive (HD) 112, and a digital file acquiring unit 117.

A physical mark is added to a document 102 as a specifying mark. In an example shown in FIG. 1, different physical marks, for example, a physical mark 120 as a barcode, a physical mark 121 as a watermarked image, a physical mark 122 as text information, are arranged on the document 102. Even if any one of the physical marks, for example, the physical mark 120 is destroyed or in a state beyond recognition, it is possible to retain traceability information by the other physical marks 121 and 122. The term “traceability” as used herein is defined as “the ability to find the history, application, and location of a target object”. Specifically, traceability refers to “history of process” and “source of a material and a part”.

The information extracting unit 105 performs at least one of an optical character recognition (OCR), a watermarked image identification process, and decoding by a radio frequency identification (RFID) reader.

The process selecting unit 104 selects a process, a printing mode and the like in interaction with a user. Examples of the process include copying, printing, and network transfer. Examples of the printing mode include all page printing and printing of a single page currently scanned by the scanner 103. The process selecting unit 104 includes a display device and an input device for an interactive interface (I/F).

The user identifying unit 107 includes an input unit such as a keyboard and a mouse for inputting a password depending on a form of user ID, a magnetic card reading device, and an RFID reader.

The traceability-information generating unit 106 is connected to the information extracting unit 105 and the user identifying unit 107. The traceability-information generating unit 106 obtains document information from the information extracting unit 105 and user ID from the user identifying unit 107 to generate new traceability information. The new traceability information is sent to the printer engine 109

The printer engine 109, which is a unit for generating updated documents, replaces the physical marks 120, 121, and 122 attached to the document with a new physical mark including the new traceability information generated by the traceability-information generating unit 106.

### Alternatively, the printer engine 109 arranges the new physical mark in a different area than where the physical marks 120, 121, and 122 resides, and forms an image, which is then printed to obtain a printed document 115 and output.

The use history recording unit 108 stores, on the HD 112 of the MFP 101, use history including an user ID, traceability information, and a serial number for identifying the MFP 101.

By connecting the MFP 101 to a network 110 such as the Internet, the use history can be stored in a server 113 through the network 110 or on the hard disc of a client personal computer (PC) 116 via the server 113.

The access-history recording unit 111 monitors the use history, and records access history each time access occurs. The access history can be stored in the server 113 or on a hard disc of another MFP 114 connected via the network 110 to the MFP 101.

The MFP 101 can include a PC motherboard to realize functions thereof. Specifically, processes performed by the information extracting unit 105 such as OCR and watermarked image identification process, processes performed by the process selecting unit 104, the traceability-information generating unit 106, the use history recording unit 108, and the access-history recording unit 111 can be implemented in software. Further, storage of the use history via the network 110, storage of the access history, and issuance of a print command for replacing a physical mark in the printer engine 109 can also be implemented in software. The storage of the use history and the access history can be performed as network processing through HyperText Transport Protocol (HTTP).

The digital file acquiring unit 117 retains link information between information obtained by the information extracting unit 105 and a digital file previously stored in the HD 112 or the server 113, and acquires the digital file for sending it to the printer engine 109.

The printer engine 109 performs processes selected by the process selecting unit 104. For example, the printer engine 109 prints all pages of a document in the digital file acquired by the digital file acquiring unit 117 or only a page of the document 102 that is currently scanned by the scanner 103.

That is, the printer engine 109 can print a document in a digital file acquired by the digital file acquiring unit 117 as well as a document read by the scanner 103.

As described above, in the image forming apparatus that includes the image processing device according to the first embodiment, the process selecting unit 104 allows a user to select at least one of the processes for data scanned from the document 102. The information extracting unit 105 extracts document information embedded in the physical marks 120, 121, and 122 on the document 102. The user identifying unit 107 identifies the user. The traceability-information generating unit 106 generates traceability information from the document information extracted by the information extracting unit 105 and the identification result obtained by the user identifying unit 107. The printer engine 109 generates an update document with a new physical mark containing the traceability information based on one or more processes selected by the user through the process selecting unit 104. Thus, it is possible to create a document with a physical mark that contains traceability information each time image forming process is performed, and to ensure easy traceability of information.

Moreover, because the image forming apparatus is configured as the MFP 101 that includes the scanner 103 and the printer engine 109, it is possible to ensure easy traceability of information in the image forming processes such as copying, faxing, printing, and data transfer and acquisition through a network.

The physical mark is in any one of forms including numbers, letters or characters, a dot pattern, a barcode, a two-dimensional code, a quick response (QR) code, a watermarked image, and RFID. A combination of two or more physical marks is attached to the document 102 to form an image of the document 102. The physical marks can be in different forms.

Thus, even if a malicious user tries to destroy a physical mark on the document 102, in an attempt to delete traceability information, traceability information of the document 102 is retained so long as all the physical marks are not destroyed.

The physical mark contains traceability information generated from user information and document information. The image forming apparatus includes the HD 112 as a digital file storage unit. The physical mark contains the document ID that indicates a link between a document and a digital file. The traceability-information generating unit 106 is configured to generate traceability information using document information extracted from the document 102, user ID, ID of the image forming apparatus, and document ID.

With such configuration and operation, it is possible to perform image forming process, in which a document ID is extracted from the physical mark, so that the digital file acquiring unit 117 can retrieve a corresponding digital file. A physical mark that contains traceability information is attached to the digital file to create a document. As a result, it is possible to easily acquire a digital document from the physical mark, and obtain a document with a new physical mark that contains update traceability information including past traceability history.

The image forming apparatus is connected to the network 110. In such configuration, even if a digital file is stored in a distant place that is accessible through a local area network (LAN), the Internet or the like, such as IDC, a digital document, whose traceability information is secured, can be obtained from the digital file.

One or more physical marks each containing traceability information are printed on the printed document 115, which ensures easy traceability from the printed document 115.

The image forming apparatus includes the user identifying unit 107 that records user log. The use history recording unit 108 records history of accesses to the user log, and also writes document information extracted from a physical mark attached to a scanned document to the user log. Incidentally, it is evident from the above explanation that the document information corresponds to the traceability information. Accordingly, traceability can be ensured by the physical mark and by the user log as well. It is possible to manage access history of the user log, which provides high level of security for the traceability information.

The image forming apparatus is connected to the network 110, and therefore, can store the user log recorded by the user identifying unit 107 and the access history recorded by the use history recording unit 108 in a storage device, etc. in a distant place accessible via the LAN and the Internet, which provides high level of security for the traceability information.

Thus, according to the first embodiment, it is possible to provide easy access to the entire text of a digital file by a physical mark which is added to a URL or printed on or physically attached to paper. Monitoring of accesses to a document ensures traceability of the document. The traceability information is embedded in a physical mark to be printed, and therefore, it is possible to ensure traceability after printing. Each time a document is printed or a digital file is obtained through the network, update traceability information is generated that includes past traceability information. That is, a physical mark on the printed document or the digital file ensures easy and exact traceability even when the user log cannot be monitored. Further, a plurality of physical marks is printed on or attached to the same document or the like, which further ensures traceability. The physical marks can be in different forms.

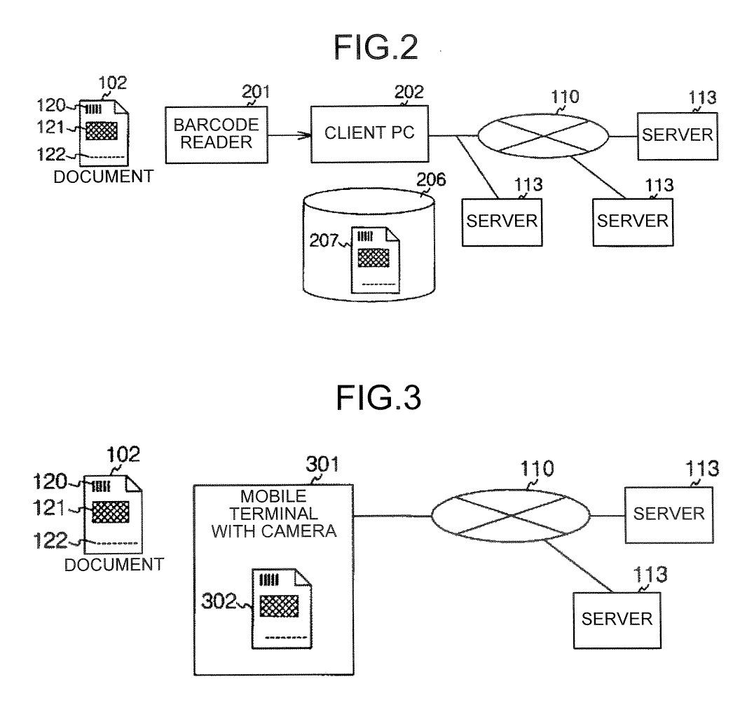

FIG. 2 is a schematic of an image processing device according to a second embodiment of the present invention. A barcode reader 201 reads the physical mark 120 on the document 102, and sends read information to a client PC 202. At this time, the physical mark 120 contains ID of a digital file 207 stored in the server 113. The client PC 202 sends the digital file ID to the server 113 via the network 110, and the server 113 retrieves the digital file 207 based on the digital file ID and transfers the digital file 207 to the client PC 202. Upon receiving the digital file 207 from the server 113, the client PC 202 stores, in a built-in storage device 206, the digital file 207 attached with a physical mark that contains traceability information.

In the second embodiment, the barcode reader 201 is used as a device to read the physical mark 120 on the document 102. However, the barcode reader 201 is cited merely by way of example, and the physical mark 120 can be read by any one of a barcode reader, a QR code reader, and an RFID reader, or a combination thereof.

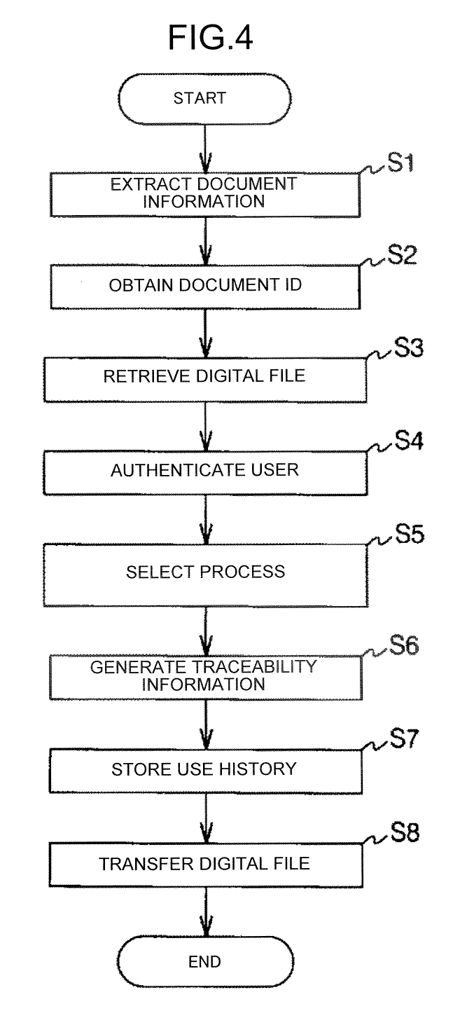

FIG. 4 is a flowchart of the operation of the image processing device according to the second embodiment. A process explained in FIG. 4 is performed by the client PC 202. First, at steps S1 and S2, document information is extracted from the physical mark 120, and a document ID is obtained as link information to a digital file.

At step S3, the digital file is retrieved. Next, at step S4, a user is authenticated. User authentication is performed with a user ID and a password input through a keyboard of the client PC 202, or using a magnetic card or biometrics such as fingerprints by attaching a magnetic card reader or a biometrics scanner to the client PC 202. When the user is authenticated, at step S5, the user selects any of image-forming processes. The selection is made with a mouse or the keyboard.

Next, at step S6, traceability information is generated based on the user ID and the document information extracted from the physical mark 120. If the physical mark 120 has contained past traceability information, the newly generated traceability information includes the past traceability information.

At step S7, the use history including access to the digital file, user history, and the traceability information, is stored in the server 113. At step S8, the digital file is transferred from the server 113 to the client PC 202. The physical mark 120, which contains the new traceability information generated at step S6, is attached to the digital file.

The digital file is transferred according to the process selected by the user at step S5. For example, all pages or only a page of the document 102 from which the physical mark 120 has read is transferred. All or part of the processes at steps S3 to S7 is performed by the server 113. The configuration mentioned above also has the same effect as the first embodiment.

FIG. 3 is a schematic of an image processing device according to a third embodiment of the present invention. As shown in FIG. 3 a mobile terminal with camera 301 is connected to a network such as the Internet, and an image of the document 102 captured by the mobile terminal with camera 301 is transferred to the server 113. The server 113 reads the physical marks 120, 121, and 122 from the image, and obtains a document ID. The server 113 retrieves a digital file 302 corresponding to the document ID, and transfers the digital file 302 as desired by the user. A series of the processes is performed as previously described in connection with the flowchart of FIG. 4. That is, the processes explained in FIG. 4 are performed by the mobile terminal with camera 301. Detailed explanation of the processes is omitted.

In FIG. 3, the digital file 302 is transferred to the user with the physical mark, which contains the traceability information obtained according to the flowchart of FIG. 4. Thus, the mobile terminal with camera 301 receives the digital file 302 attached with the physical mark. The configuration mentioned above also has the same effect as the first embodiment.

Although the embodiments are described on the assumption that data to be processed is document data, document is cited merely by way of example and without limitation. The data can be a table, an image, directories, a combination thereof, and the like.

As set forth hereinabove, according to an embodiment of the present invention, document information extracted by a document information extracting unit corresponds to traceability information. Each time an imaging process is performed by an image processing device, a user ID, a process identifying code related to the image process selected by a process selecting unit and an ID of an image forming apparatus are accumulatedly recorded, and thereby forming the traceability information.

That is, each time a document is image-processed, information on operations required by a user is accumulatedly recorded on an output document with a specific mark. Thus, traceability can be ensured. Moreover, security of the document can be ensured by recording the operations required by the user on a log.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing device that is applied to an image forming apparatus that performs at least one of image processes including copying, printing, and faxing, the image processing device comprising:
a selecting unit that causes a user to select at least one of the image processes for data;
an information extracting unit that extracts, when a specific mark is attached to the data, information contained in the specific mark;
an identifying unit that identifies the user to obtain an identification result;
a traceability-information generating unit that generates traceability information of the data from extracted information and the identification result; and
an update data generating unit that generates update data attached with a specific mark that contains generated traceability information based on selected image process.

2. The image processing device according to claim 1, wherein the extracted information is traceability information.

3. The image processing device according to claim 1, wherein the traceability generating unit generates the traceability information using at least one of identification information of the user, the extracted information, and a process identifying code related to the selected image process and identification information of the image forming apparatus.

4. The image processing device according to claim 1, further comprising a storing unit that stores the data in a form of a digital file in a storage area, wherein
the specific mark contains data identification information of the digital file.

5. The image processing device according to claim 4, further comprising a digital file retrieving unit that retrieves the digital file from the storing unit based on the data identification information, wherein
the selected image process is performed with respect to the acquired digital file.

6. The image processing device according to claim 1, wherein the imaging process is denied when the user is not identified.

7. The image processing device according to claim 1, wherein the selecting unit causes the user to select any one of a process of only a page that contains the specific mark and a process of all pages.

8. The image processing device according to claim 1, wherein, when the specific mark is not attached to the data, the selected image process is performed without processes performed by the identifying unit and the traceability-information generating unit.

9. The image processing device according to claim 1, wherein the data is any one of a digital data obtained by scanning a document, a digital data created and edited by using a personal computer, a digital data created and edited by a work station, and a digital data created automatically by an office process related to a corporate business, and includes at least one of text and an image.
